(19) United States
(12) Patent Application Publication
(10) Pub. No.: US 2002/0106481 A1
(43) Pub. Date: Aug. 8, 2002

(54) Fabric tape structure provided with a decorative effect and a means to give off or reflect light

(75) Inventor: Hsy-Chi Lin, Chan Hua Hsien (TW)

Correspondence Address: HARRISON & EGBERT, 412 MAIN STREET, 7TH FLOOR, HOUSTON, TX, 77002, US

(73) Assignee: Majectic Webbing Industry Co., Ltd.

(21) Appl. No.: 09/773,739

(22) Filed: Feb. 2, 2001

(51) Int. Cl. D04H 1/00; B32B 3/06

(52) U.S. Cl. 428/102; 428/156; 428/343; 442/151; 442/183; 442/328

(57) ABSTRACT

A fabric tape structure is formed of a fabric tape and an elastic strip attached to the surface of the fabric tape. The elastic strip is provided with words, marks, and patterns, which are printed thereon. The elastic strip is coated with a fluorescent of light-reflecting substance.

### FIELD OF THE INVENTION

The present invention relates generally to a fabric tape structure, and more particularly to a fabric tape structure that is used as a warning flag, a pet collar, a packaging tape, etc.

### BACKGROUND OF THE INVENTION

The conventional fabric tape is generally primitive in design and is devoid of decorative effect and means to make the fabric tape conspicuous to the naked eye. As a result, the purpose of the conventional fabric tape is seriously compromised.

### SUMMARY OF THE INVENTION

The primary objective of the present invention is to provide a novel fabric tape which is provided with a decorative effect and a warning effect.

The fabric tape of the present invention comprises a strip which is coated with a fluorescent substance or a light-reflecting substance. The strip is further provided with a plurality of words, marks, patterns, etc.

The objective, features, and advantages of the present invention will be more readily understood upon a thoughtful deliberation of the following detailed description of the present invention with reference to the accompanying drawings.

### BRIEF DESCRIPTION OF THE DRAWINGS

FIG. 1 shows a perspective view of the present invention.

FIG. 2 shows an exploded view of the present invention.

FIGS. 3A, 3B, and 3C show schematic views of various forms of the present invention.

FIG. 4 shows another perspective view of the present invention.

FIG. 5 shows a schematic view of the present invention being used as a pet collar.

FIG. 6 shows a schematic view of the present invention being used as a warning sign.

FIG. 7 shows a schematic view of the present invention being used as a warning flag.

FIG. 8 shows a schematic view of the present invention being used as a packaging tape.

### DETAILED DESCRIPTION OF THE INVENTION

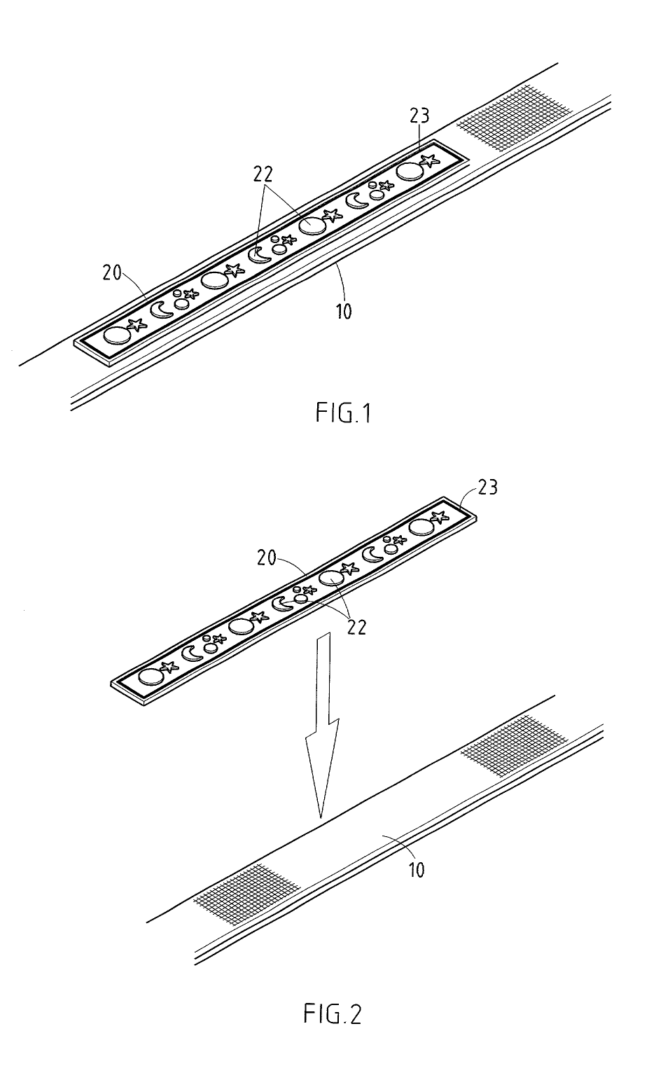

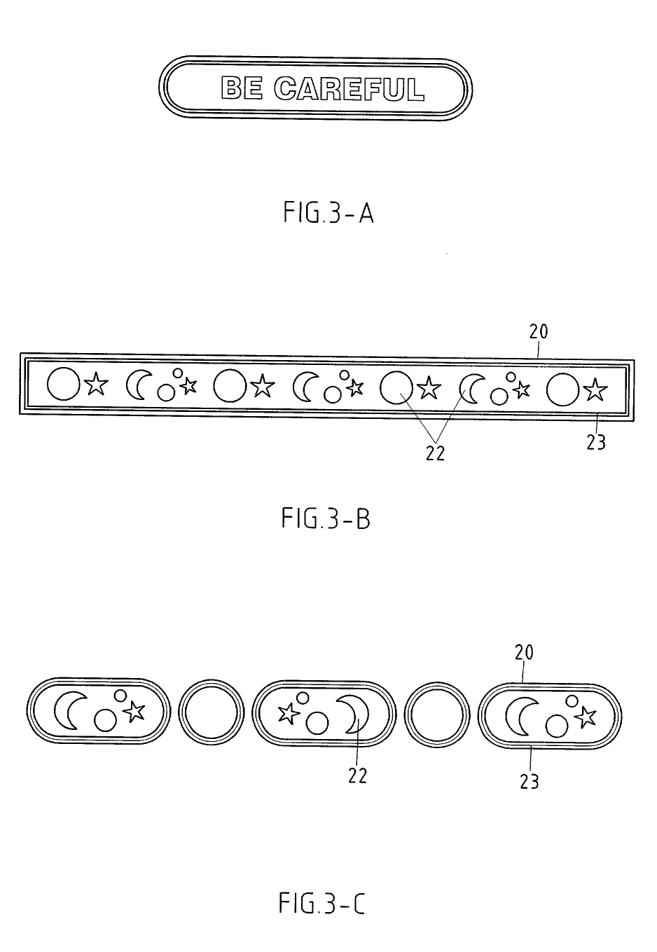

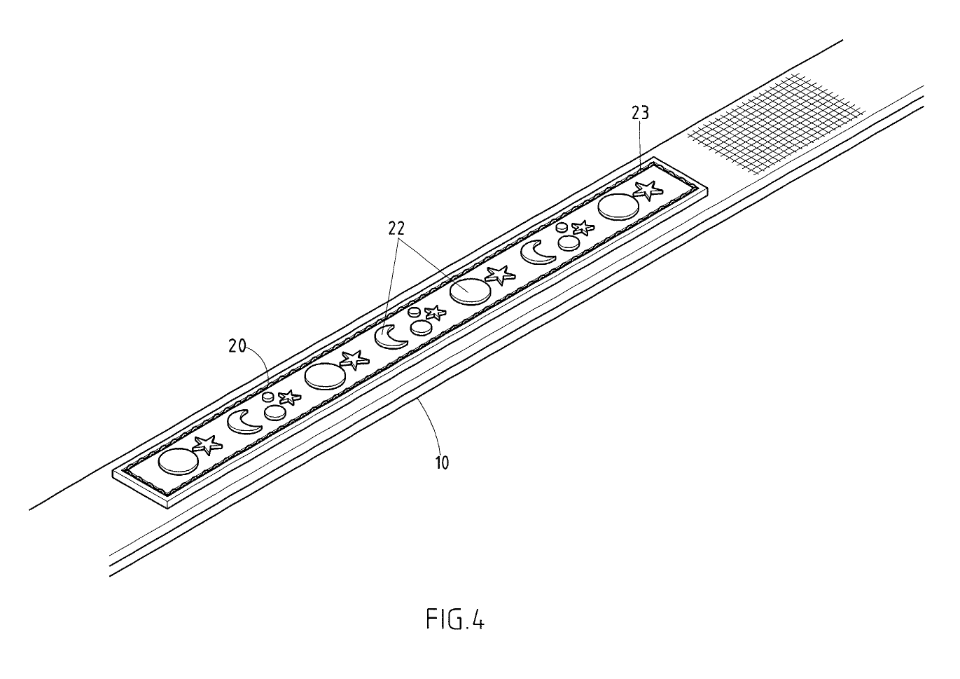

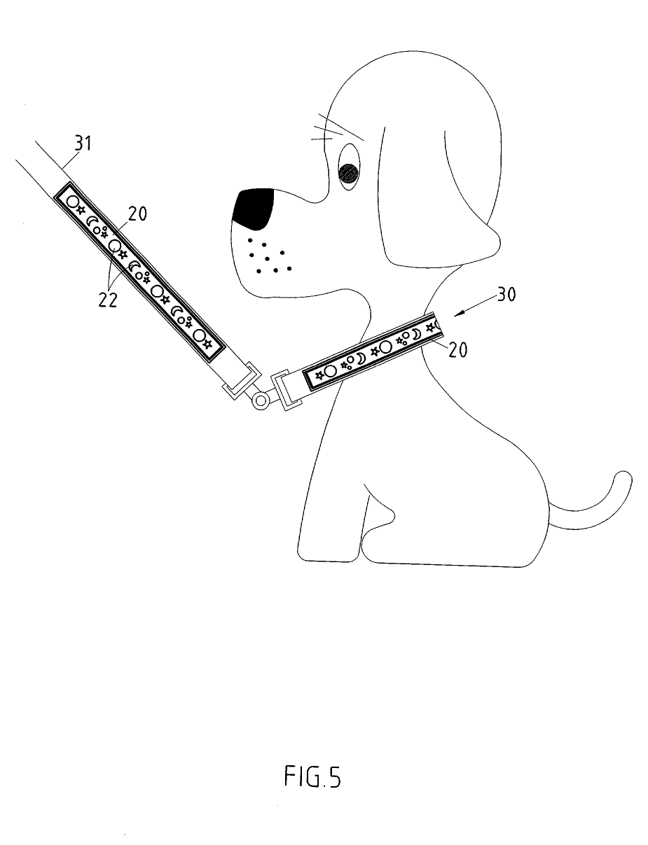

As shown in FIGS. 1-4, a fabric tape structure of the present invention comprises a fabric tape 10 and an elastic strip 20, which is attached to the surface of the fabric tape 10. The strip 20 is made of a synthetic polymer, Such as polyvinyl chloride, polyurethane, etc.

The strip 20 is coated with a fluorescent substance or a light-reflecting substance.

The strip 20 is provided with a plurality of words, marks, or patterns 22, which are printed thereon such that the words, marks, and patterns 22 are embossed, depressed, or flush the surface of the strip 20.

The strip 20 is attached to the surface of the fabric tape 10 by an adhesive, a high freguency fusion, or by sewing along a groove 23 which is provided in the surface of the strip 20.

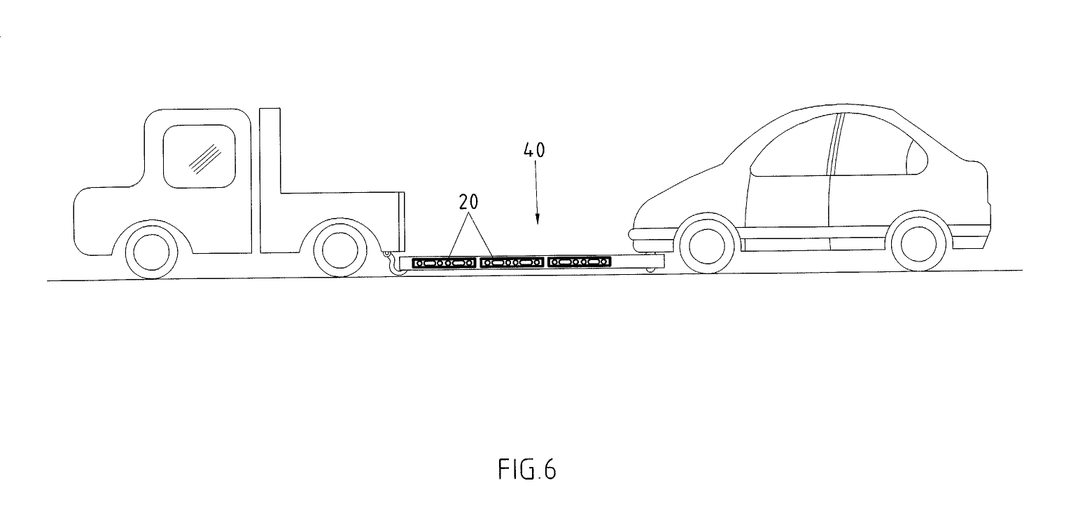

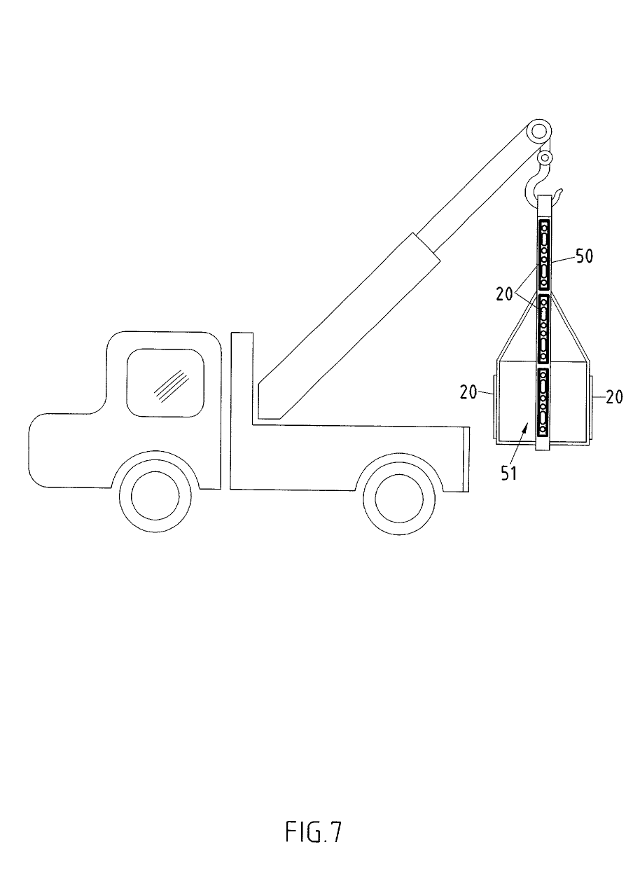

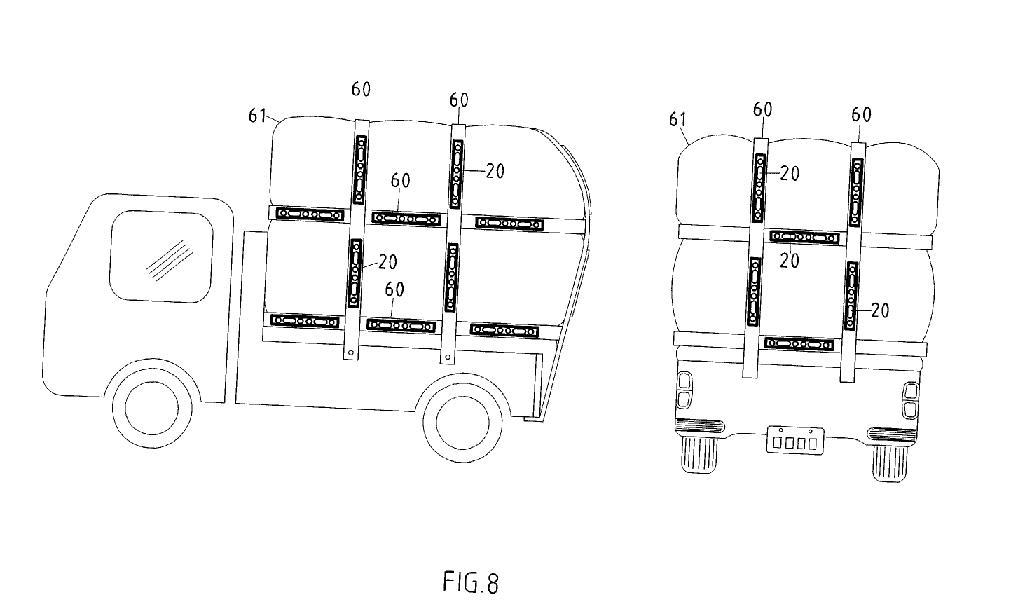

The fabric tape structure of the present invention is used for various purposes. As shown in FIG. 5, the present invention is used as a pet collar 30 as well as a decorative tape that is attached to a pet-guiding rope 31. The present invention may be attached to a towing chain 40 to give it a warning effect, as shown in FIG. 6. Similarly, the present invention may be attached to a hauling rope 50 for hauling a cargo 51, as shown in FIG. 7. The present invention may be attached to the packaging ropes 60 for packaging goods 61, as shown in FIG. 8.

The embodiment of the present invention described above is to be regarded in all respects as being merely illustrative and not restrictive. Accordingly, the present invention may be embodied in other specific forms without deviating from the spirit thereof. The present invention is therefore to be limited only by the scopes of the following appended claims.

What is claimed is:

1. A fabric tape structure comprising:
a fabric tape; and
an elastic strip attached to the surface of said fabric tape and provided with a plurality of words, marks, and patterns, which are printed thereon.

2. The fabric tape structure as defined in claim 1, wherein said elastic strip is attached to the surface of said fabric tape by an adhesive.

3. The fabric tape structure as defined in claim 1, wherein said elastic strip is attached to the surface of said fabric tape by sewing.

4. The fabric tape structure as defined in claim 1, wherein said elastic strip is attached to the surface of said fabric tape by a high freguency fusion.

5. The fabric tape structure as defined in claim 1, wherein said elastic strip is coated with a fluorescent substance.

6. The fabric tape structure as defined in claim 1, wherein said elastic strip is coated with a light-reflecting substance.

7. The fabric tape structure as defined in claim 1, wherein the words, marks and patterns of said elastic strip are embossed, depressed, or flush with the surface of said elastic strip.
